(19) United States
(12) Patent Application Publication
(10) Pub. No.: US 2006/0083412 A1
(43) Pub. Date: Apr. 20, 2006

(54) Fingerprint image collator

(75) Inventor: Katsuhiko Satoh, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD., Tokyo (JP)

(21) Appl. No.: 11/252,356

(22) Filed: Oct. 17, 2005

(30) Foreign Application Priority Data
Oct. 19, 2004 (JP) 2004-304467

(51) Int. Cl. G06K 9/00

(52) U.S. Cl. 382/124

(57) ABSTRACT

An image collator includes a first region disposing unit which disposes plural first regions on a first fingerprint image in a fixed positional relation, a first maximum correlation region detecting unit which detects a maximum correlation region whose correlation with image data of each of the first regions becomes maximum from a second fingerprint image, a second region disposing unit which disposes plural second regions on the first fingerprint image in accordance with a positional relation of the maximum correlation regions, a second maximum correlation region detecting unit which detects a region whose correlation with image data of each of the second regions from the second fingerprint image, and a determining unit which determines whether or not identity exists between the first fingerprint image and the second fingerprint image by comparing the distribution of the regions with the distribution of the maximum correlation regions.

### CROSS-REFERENCE TO RELATED APPLICATIONS

This application is based upon and claims the benefit of priority from prior Japanese Patent Application No. 2004-304467, filed Oct. 19, 2004, the entire contents of which are incorporated herein by reference.

### BACKGROUND OF THE INVENTION

1. Field of the Invention

The present invention relates to a technology for collating fingerprint image data, and more particularly, to a technology capable of maintaining the accuracy of collation of images even for fingerprint image data in which a defective portion exists in part of an image thereof.

2. Description of the Related Art

As an applied field of an image collator which collates an image registered in database or the like preliminarily with a collation image acquired by an image sensor or the like, a field of fingerprint collation can be mentioned.

As for a conventional image collator, in registered fingerprint image data (hereinafter referred to as registered image data) A and fingerprint image data (hereinafter referred to as collation image data) B to be collated to the registered image data A as shown in FIGS. 1A and 1B, plural rectangular regions Ai's are defined on the registered image data A and disposed in a fixed positional relation. By scanning regions having the same shape as the rectangular regions Ai's on the collation image data, regions Bi's capable of providing the maximum correlation coefficient are detected. Then, in some case, identity between the registered image data A and the collation image data B is determined by comparing the distribution of the rectangular regions Ai's disposed in the registered image data A with the distribution of the regions Bi's detected within the collation image data B.

In such an image collator, the positional relation of the plural rectangular regions Ai's disposed on the registered image data A is fixed. For this reason, if there exists a region which is distorted or crushed so that its shade is uniform or blurred in the regions on the collation image data corresponding to the plural rectangular regions Ai's disposed on the registered image data A, there is a high possibility that erroneous rejection may occur even if the registered image data A and the collation image data B are of the same data.

### BRIEF SUMMARY OF THE INVENTION

An object of the present invention is to provide an image collator capable of inhibiting an erroneous rejection even if there exists a defective region in part of a collation image.

According to an embodiment of the present invention, there is provided an image collator for collating a first fingerprint image with a second fingerprint image, comprising:

a first region disposing unit which disposes plural first regions on the first fingerprint image in a fixed positional relation;

a first maximum correlation region detecting unit which detects a maximum correlation region whose correlation with image data of each of the first regions disposed by the first region disposing unit becomes maximum from the second fingerprint image;

a second region disposing unit which disposes plural second regions on the first fingerprint image in accordance with a positional relation of the maximum correlation regions detected by the first maximum correlation region detecting unit;

a second maximum correlation region detecting unit which detects a region whose correlation with image data of each of the second regions disposed by the second region disposing unit from the second fingerprint image; and

a determining unit which determines whether or not identity exists between the first fingerprint image and the second fingerprint image by comparing the distribution of the regions disposed by the first region disposing unit and the second region disposing unit with the distribution of the maximum correlation regions detected by the first maximum correlation region detecting unit and the second maximum correlation region detecting unit.

According to another embodiment of the present invention, there is provided an image collator for collating a first fingerprint image with a second fingerprint image, comprising:

a first region disposing unit which disposes plural first regions on the first fingerprint image in a fixed positional relation;

a first maximum correlation region detecting unit which detects a maximum correlation region whose correlation with image data of each of the first regions disposed by the first region disposing unit becomes maximum from the second fingerprint image;

a determining unit which determines whether or not the collation is enabled by comparing the distribution of the regions disposed by the first region disposing unit with the distribution of the maximum correlation regions detected by the first maximum correlation region detecting unit;

a first determining unit which, when the determining unit determines that the collation is enabled, determines whether or not identity exists between the first fingerprint image and the second fingerprint image by comparing the distribution of the regions disposed by the first region disposing unit with the distribution of the maximum correlation regions detected by the first maximum correlation region detecting unit;

a second region disposing unit which, when the determining unit determines that the collation is not enabled, disposes plural second regions on the first fingerprint image in accordance with a positional relation of the maximum correlation regions detected by the first maximum correlation region detecting unit;

a second maximum correlation region detecting unit which detects a maximum correlation region whose correlation with image data of each of the second regions disposed by the second region disposing unit becomes maximum from the second fingerprint image; and

a second determining unit which determines whether or not identity exists between the first fingerprint image and the second fingerprint image by comparing the distribution of the regions disposed by the first region disposing unit and the second region disposing unit with the distribution of the maximum correlation regions detected by the first maximum correlation region detecting unit and the second maximum correlation region detecting unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are views for explaining a conventional image collation method;

FIG. 2 is a block diagram showing a functional configuration of an image collator according to first and second embodiments of the present invention;

FIG. 3 is a flow chart for explaining the operation of the image collator applied to fingerprint collation in accordance with the first embodiment;

FIGS. 4A, 4B and 4C are diagrams for explaining the disposition of rectangular regions disposed in registered image data A and collation image data B for explaining an image collation method of the first and second embodiments;

FIG. 5 is a diagram showing an example of a preliminarily determined arrangement relation relative to a positional relation of rectangular regions constituted of only rectangular regions whose relative deflection amount is smaller than a specified deflection amount in accordance with the first and second embodiments;

FIG. 6 is a diagram showing an example of a preliminarily determined arrangement relation relative to a positional relation of rectangular regions constituted of only rectangular regions whose relative deflection amount is smaller than a specified deflection amount in accordance with the first and second embodiments;

FIG. 7 is a diagram showing an example of a preliminarily determined arrangement relation relative to a positional relation of rectangular regions constituted of only rectangular regions whose relative deflection amount is smaller than a specified deflection amount in accordance with the first and second embodiments;

FIG. 8 is a diagram showing an example of a preliminarily determined arrangement relation relative to a positional relation of rectangular regions constituted of only rectangular regions whose relative deflection amount is smaller than a specified deflection amount in accordance with the first and second embodiments;

FIG. 9 is a diagram showing an example of a preliminarily determined arrangement relation relative to a positional relation of rectangular regions constituted of only rectangular regions whose relative deflection amount is smaller than a specified deflection amount in accordance with the first and second embodiments;

FIG. 10 is a diagram showing an example of a preliminarily determined arrangement relation relative to a positional relation of rectangular regions constituted of only rectangular regions whose relative deflection amount is smaller than a specified deflection amount in accordance with the first and second embodiments;

FIG. 11 is a diagram showing an example of a preliminarily determined arrangement relation relative to a positional relation of rectangular regions constituted of only rectangular regions whose relative deflection amount is smaller than a specified deflection amount in accordance with the first and second embodiments;

FIG. 12 is a diagram showing an example of a preliminarily determined arrangement relation relative to a positional relation of rectangular regions constituted of only rectangular regions whose relative deflection amount is smaller than a specified deflection amount in accordance with the first and second embodiments;

FIG. 13 is a diagram showing an example of a preliminarily determined arrangement relation relative to a positional relation of rectangular regions constituted of only rectangular regions whose relative deflection amount is smaller than a specified deflection amount in accordance with the first and second embodiments; and

FIG. 14 is a flow chart for explaining the operation of the image collator applied to fingerprint collation in accordance with the second embodiment.

### DETAILED DESCRIPTION OF THE INVENTION

### FIRST EMBODIMENT

An image collator according to a first embodiment is realized by a computer system in which a CPU, a storage unit, a RAM, an image reader (scanner unit), a display unit, an input unit and the like are connected mutually.

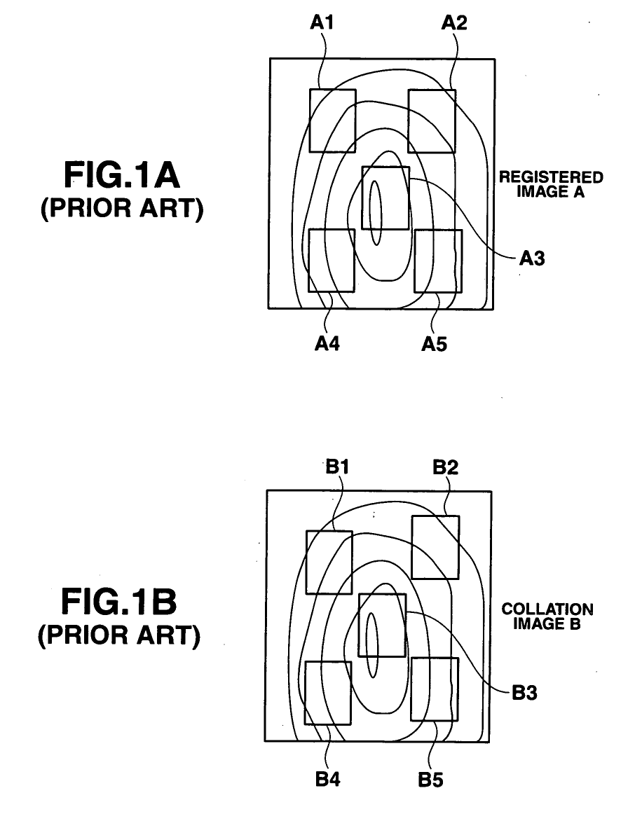

The CPU controls the operation of the entire image collator by using the RAM as a work area in accordance with a control program stored in the storage unit. The CPU carries out fingerprint collation processing by executing an image collation program to execute processing of each functional unit shown in FIG. 1.

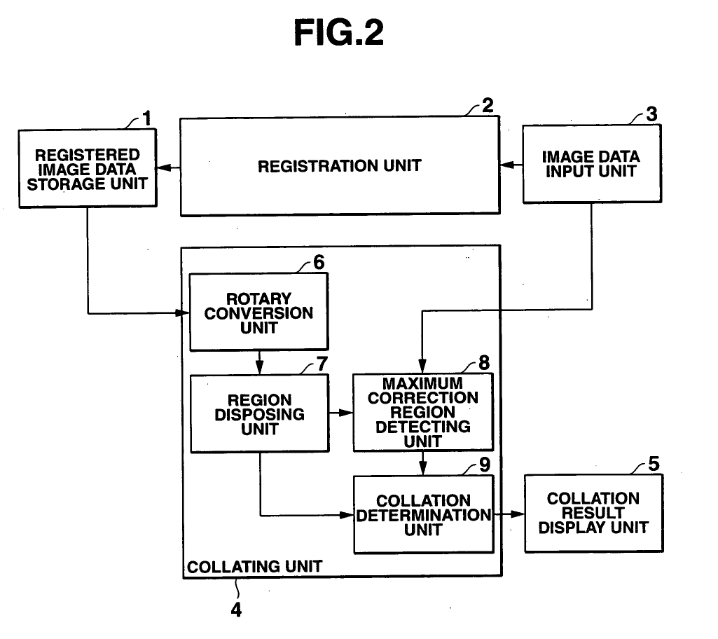

FIG. 2 is a block diagram showing a functional configuration of the image collator according to the first embodiment. The image collator of the first embodiment is constituted of a registered image data storage unit 1, a registration unit 2, an image data input unit 3, a collating unit 4, and a collation result display unit 5.

The registered image data storage unit 1 stores image data (fingerprint image data) inputted from the image data input unit 3 as registered image data A.

The registration unit 2 causes the registered image data storage unit 1 to store image data inputted from the image data input unit 3.

The image data input unit 3 inputs registered image data A to be stored in the registered image data storage unit 1 or image data (collation image data B) to be collated through an unillustrated image reader (scanner unit) or the like.

The collation unit 4 executes collation processing on the collation image data B inputted from the image data input unit 3 on the basis of the registered image data A stored in the registered image data storage unit 1.

The collation result display unit 5 displays a collation result of the collation unit 4 (collation determination unit 9).

The collation unit 4 is provided with a rotary conversion unit 6, a region disposing unit 7, a maximum correlation region detecting unit 8, and a collation determination unit 9.

The rotary conversion unit 6 rotary-converts the registered image data A by a predetermined rotation angle so as to meet even a case where inputted collation image data is tilted.

Of N (N≧3) regions (templates) Ai's (1≦i≦N) defined with a predetermined shape on the registered image data A, the region disposing unit 7 disposes M (M≦N) regions Ai's (1≦i≦M) in a fixed positional relation. A rectangular region is used as the region. Further, the region disposing unit 7 variably disposes remaining (N−M) regions Ai's (M≦i≦N) in a positional relation of maximum correlation regions in which a relative deflection introduced by the collation determination unit 9 described later becomes smaller than a specified deflection amount.

The maximum correlation region detecting unit 8 detects regions Bi's in which correlation coefficient calculated from pixel data in each of the regions Ai's and pixel data in the corresponding collation image data B becomes maximum from the collation image data B while scanning regions having the same shape as the regions Ai's (1≦i≦M) disposed by the region disposing unit 7 on the collation image data B. The maximum correlation region detecting unit 8 detects regions Bi's in which a correlation coefficient calculated from pixel data in each of the regions Ai's and pixel data in the corresponding collation image data B becomes maximum from the collation image data B while scanning regions having the same shape as the regions Ai's (M≦i≦N) disposed by the region disposing unit 7 on the collation image data B.

The collation determination unit 9 detects a region in which a relative deflection amount is smaller than a specified deflection amount by comparing the position of each of the regions Ai's (1≦i≦M) with the position of the corresponding region Bi (1≦i≦M). The collation determination unit 9 counts the quantity of pairs of regions in which the relative deflection amount is smaller than the specified deflection amount. When the quantity of the region pairs is larger than a specified quantity of region pairs, it is determined that the registered image data A and the collation image data B are identical to each other, and on the other hand, when the quantity of the region pairs is smaller than the specified quantity of region pairs, it is determined that the registered image data A and the collation image data B are not identical to each other.

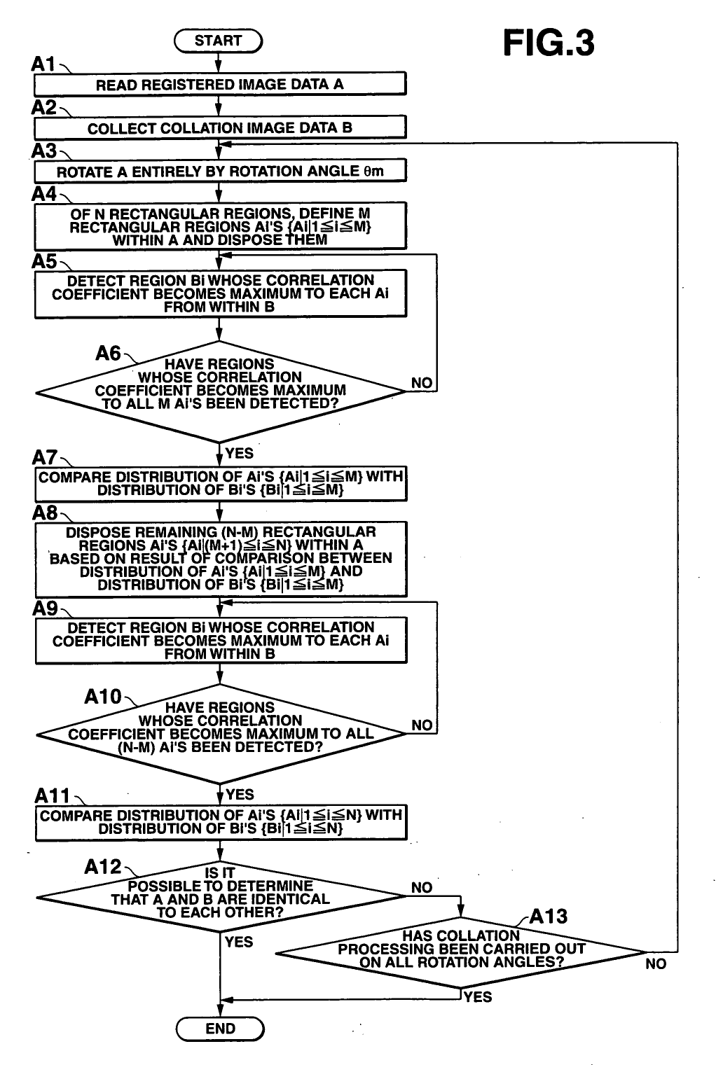

Next, the operation of the image collator of the first embodiment will be described with reference to a flow chart shown in FIG. 3.

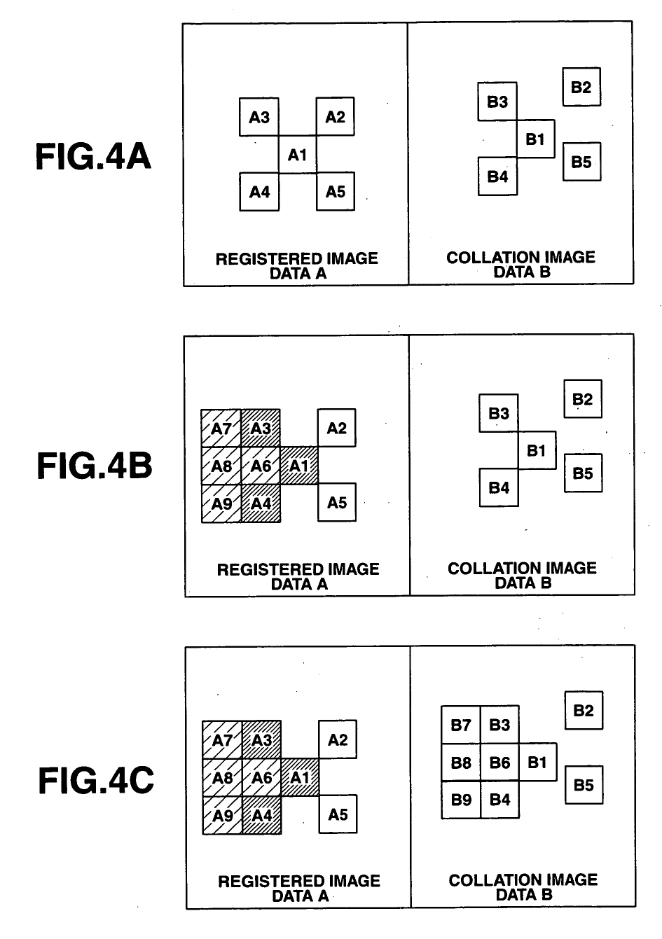

It is assumed that, in the image collator, fingerprint image data collected by the image data input unit 3 is subjected to registration processing by the registration unit 2 and stored in the registered image data storage unit 1. Further, a case of disposing nine rectangular regions (N) will be described. FIGS. 4A, 4B and 4C are diagrams showing the arrangement of rectangular regions disposed in the registered image data A and collation image data B, for explaining the image collation method.

First, the collation unit 4 reads the registered image data A by the registered image data storage unit 1 (step A1).

Next, the collation unit 4 collects the collation image data B to be collated, by means of the image data input unit 3 (step A2).

The rotary conversion unit 6 of the collation unit 4 rotates by a rotary angle of θm the entire registered image data A read from the registered image data storage unit 1 (step A3). With θm={0, 1, −1, 2, −2, . . . φ, −φ}, the collation processing is first carried out with 0° (no rotation), and as the collation processing is repeated, the registered image data is rotated by a predetermined amount, like 1°, −1°, 2°, . . . .

As shown in the registered image data A of FIG. 4A, the region disposing unit 7 disposes 5 (M) rectangular regions Ai's (Ai|1≦i≦5) in a fixed positional relation of the 9 (N) rectangular regions, on the registered image data A (hereinafter referred to as first rectangular region disposing processing) (step A4). As for the five rectangular regions, for example, a rectangular region A1 is disposed in the center of the registered image data A, and rectangular regions A2, A3 and A4 of the same size as the rectangular region A1 are disposed so as to make contact with four vertexes of the rectangular region A1.

Next the maximum correlation region detecting unit 8 detects regions Bi's {Bi|1≦i≦5} capable of obtaining the maximum correlation coefficient with respect to the respective rectangular regions Ai's {Ai|1≦i≦5} by scanning regions corresponding to the respective rectangular regions Ai's {Ai|1≦i≦5} on the collation image data B, as shown in the collation image data B of FIG. 4A (step A5).

Referring to FIG. 4A, although the maximum correlation regions B1, B3 and B4 are disposed in substantially the same manner as in the rectangular regions A1, A3 and A4 of the registered image data A, the regions B2 and B5 are disposed with a large deflection from the regions A2 and A5.

If a regions having the maximum correlation coefficient is detected for each of the M rectangular regions Ai's {Ai|1≦i≦5} (step A6: Yes), the collation determination unit 9 compares the distribution of the rectangular regions Ai's {Ai|1≦i≦5} with the distribution of the rectangular regions Bi's {Bi|1≦i≦5}. Then, the collation determination unit 9 detects a region in which a deflection of each of the rectangular regions Bi's {Bi|1≦i≦5} relative to each of the rectangular regions Ai's {Ai|1≦i≦5} is smaller than a specified deflection amount (step A7).

Next, the region disposing unit 7 decides the arrangement positions of the remaining four (N−M) rectangular regions Ai's {Ai|6≦i≦9} with respect to the registered image data A, on the basis of a positional relation of rectangular regions constituted of rectangular regions in which the amount of deflection is smaller than a specified deflection amount as shown in FIG. 4B (hereinafter referred to as second rectangular region disposing processing)(step A8).

Because the arrangement relation of the rectangular regions in which the relative deflection amount is smaller than the specified deflection amount is A1, A3 and A4 (B1, B3 and B4), the remaining rectangular regions are disposed in accordance with a predetermined arrangement relation with respect to the positional relation of the rectangular regions.

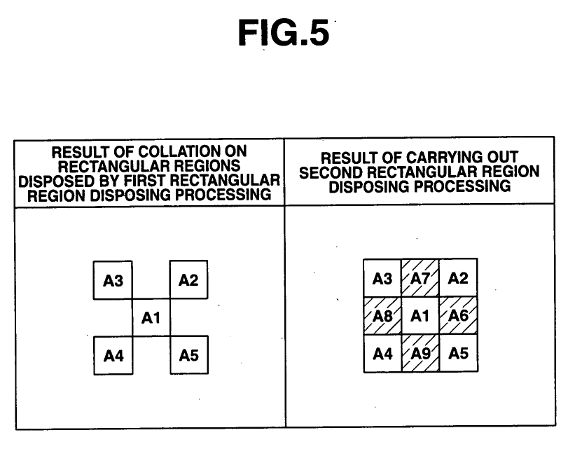

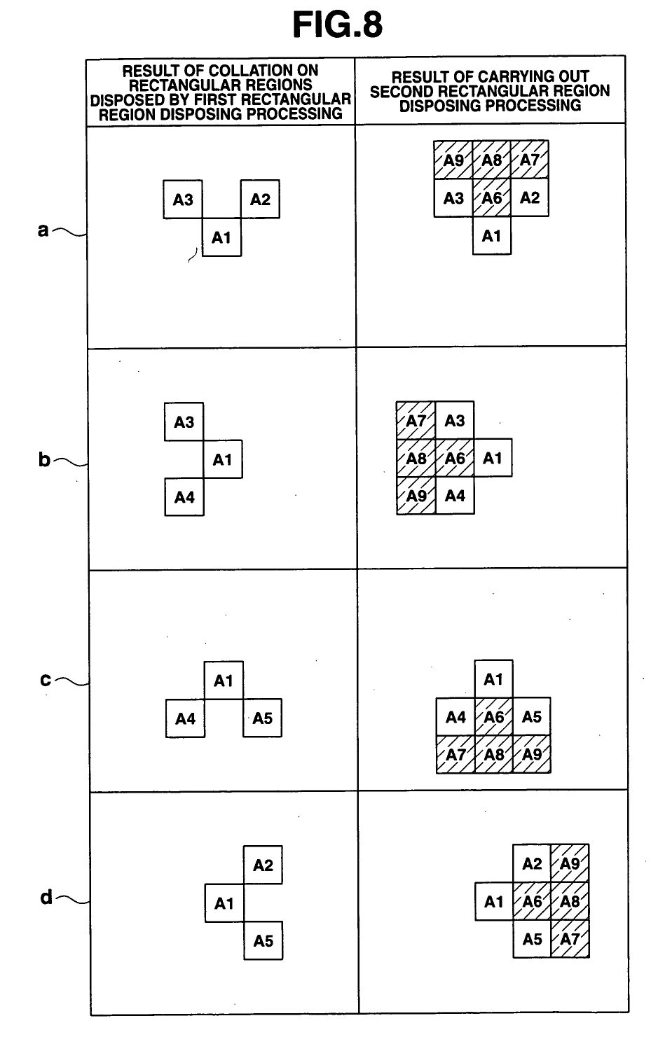

According to the first embodiment, the arrangement relation of the second regions treated in the second rectangular region disposing processing is defined as shown in FIGS. 5 to 13. The example shown in FIGS. 4A, 4B and 4C corresponds to a case of symbol “b” in FIG. 8. The detail of the arrangement relation shown in FIGS. 5 to 13 will be described later.

The maximum correlation region detecting unit 8 detects rectangular regions Bi's {Bi|6≦i≦9} capable of obtaining the maximum correlation coefficient relative to the respective rectangular regions Ai's {Ai|6≦i≦9} by scanning regions corresponding to the respective remaining rectangular regions Ai's {Ai|6≦i≦9} disposed for the second time on the collation image data B, as shown in FIG. 4C (step A9).

If a region whose correlation coefficient becomes maximum is detected to each of all (N−M) Ai's (step A10: Yes), the collation determination unit 9 compares the position of each of the rectangular regions Ai's {Ai|1≦i≦9} with the position of each of the rectangular regions Bi's {Bi|1≦i≦9) (step All). Then, rectangular regions in which the relative deflection amount is smaller than the specified deflection amount are extracted, and the quantity of region pairs are calculated. When the quantity of the region pairs is larger than a specified quantity of region pairs, it is determined that the registered image data A and the collation image data B are identical to each other (step A12: Yes).

The collation result display unit 5 outputs a determination result by the collation determination unit 9, indicating that the collation image data B is identical to the registered image data A.

When the quantity of the region pairs is smaller than the specified quantity of region pairs, on the other hand, the procedure proceeds to step A13 because it cannot be determined that image data are identical to each other, in which it is determined whether or not the processing of steps A4 to A12 described above has been carried out to all the rotation angles θm. When the processing to the all rotation angles θm is ended (step A13: Yes), it is determined that the registered image data A is not identical to the collation image data B.

The collation result display unit 5 outputs a determination result by the collation determination unit 9, indicating that the collation image data B is not identical to the registered image data A.

In the meantime, unless any processing to all the rotation angles θm is ended (step A13: No), the procedure returns to step A3 by changing the rotation angle θm under m=m+1, so as to execute the above-described processing.

The arrangement relation determined preliminarily for the positional relation of rectangular regions will be described with reference to FIGS. 5 to 13.

FIG. 5 shows rectangular regions disposed by the first rectangular region disposing processing, indicating a positional relation of the rectangular regions in case where there are five rectangular regions whose relative deflection amount is smaller than the specified deflection amount. In this case, four rectangular regions Ai's {Ai|6≦i≦9} are disposed adjacent to the rectangular region A1 in the center in the second rectangular region disposing processing.

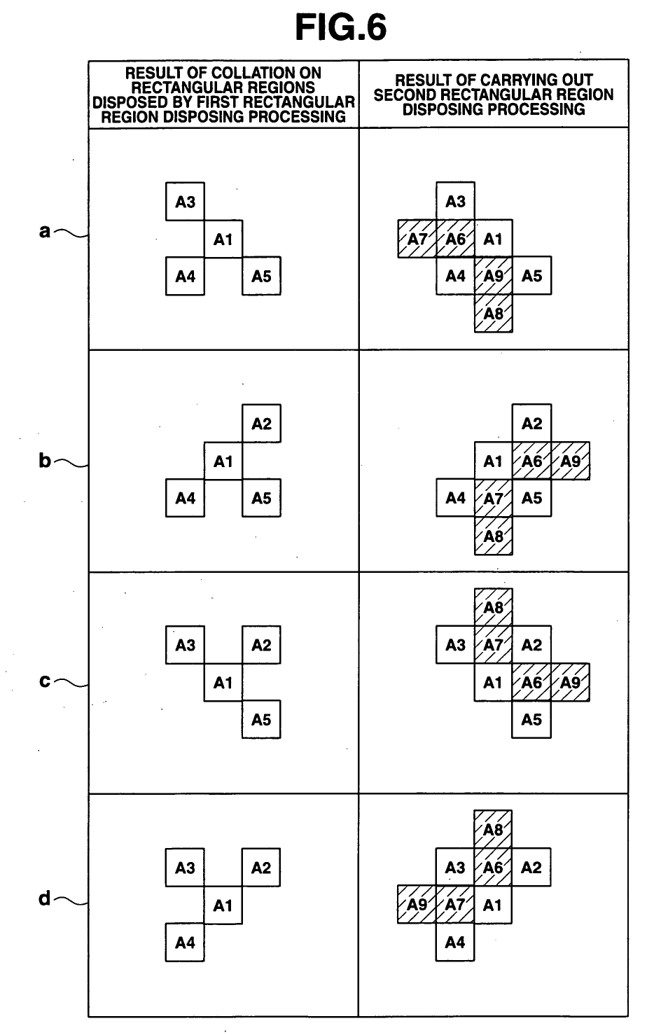

FIG. 6 shows a positional relation of second rectangular regions A6 to A9 disposed for the second time in a case where there are four rectangular regions whose deflection is smaller than the specified amount. In symbols “a” to “d” in FIG. 6, any one of the rectangular regions A2, A3, A4 and A5 to be disposed around the rectangular region A1 is not contained. In this case, four rectangular regions Ai's {Ai|6≦i≦9} are disposed so as to make contact with rectangular regions whose deflection is determined to be smaller than the specified deflection amount, in the second rectangular region disposing processing. For example, in an example indicated with symbol “a”, the rectangular region A6 is disposed between the rectangular regions A3 and A4, and the rectangular region A7 is disposed at a position at which it makes contact with the vertexes of the rectangular regions A3, A4 or adjacent to the rectangular region A6. Likewise, the rectangular region A9 is disposed between the rectangular regions A4 and A5, and the rectangular region A8 is disposed adjacent to the rectangular region A9. Here, four rectangular regions are disposed on an opposite side to the position at which the rectangular region A2 whose relative deflection amount is determined not to be smaller than the specified deflection amount and the central position (rectangular region A1). That is, since the rectangular region A2 has a probability that its relative deflection amount is increased because of a defective image such as distortion, crush or blurring, the four rectangular regions are disposed away from the region A2. Also in cases indicated with symbols “b” to “d” in FIG. 6, four rectangular regions are disposed while avoiding the positions of rectangular regions whose relative deflection amount is determined not to be smaller than the specified deflection amount.

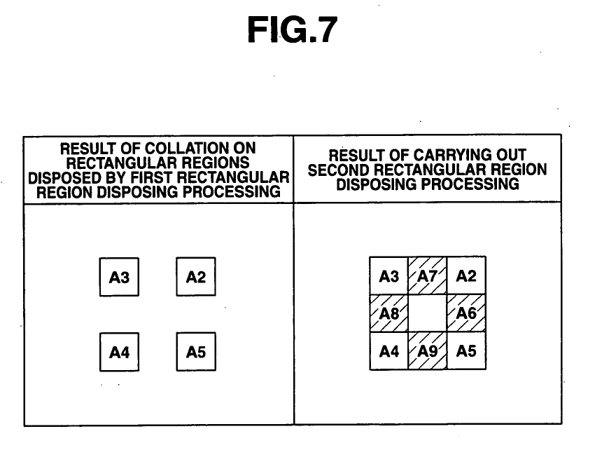

FIG. 7 also shows a positional relation of rectangular regions in case where four rectangular regions are provided. In FIG. 7, the rectangular region A1 disposed in the center is not contained. In this case, four rectangular regions Ai's {Ai|6≦i≦9} are disposed so that they are located between the surrounding regions A2, A3, A4 and A5 and adjacent to them away from the central position in the second rectangular region disposing processing.

FIG. 8 also shows a positional relation of rectangular regions in the case where there are three rectangular regions whose deflection amount is smaller than the specified amount. In symbols “a” to “d” in FIG. 8, two regions disposed vertically or horizontally of the rectangular regions A2, A3, A4 and A5 disposed around the rectangular region A1 are not contained. In this case, four rectangular regions Ai's {Ai|6≦i≦9} are disposed so as to be in contact with rectangular regions whose deflection is determined to be smaller than the specified deflection amount, in the second rectangular region disposing processing. In symbol “a” of FIG. 8, the rectangular region A6 is disposed between the rectangular regions A2 and A3. Further, the rectangular region A8 is disposed at a position which makes contact with the vertexes of the rectangular regions A2, A3 or adjacent to the rectangular region A6, the rectangular region A9 is disposed at a position which makes contact with the rectangular regions A3, A8, and the rectangular region A7 is disposed at a position which is adjacent to the rectangular regions A2, A8. In this case also, four rectangular regions are disposed on an opposite side to positions at which the rectangular regions A4, A5 whose relative deflection amount is determined not to be smaller than the specified deflection amount are disposed and the central position (rectangular region A1).

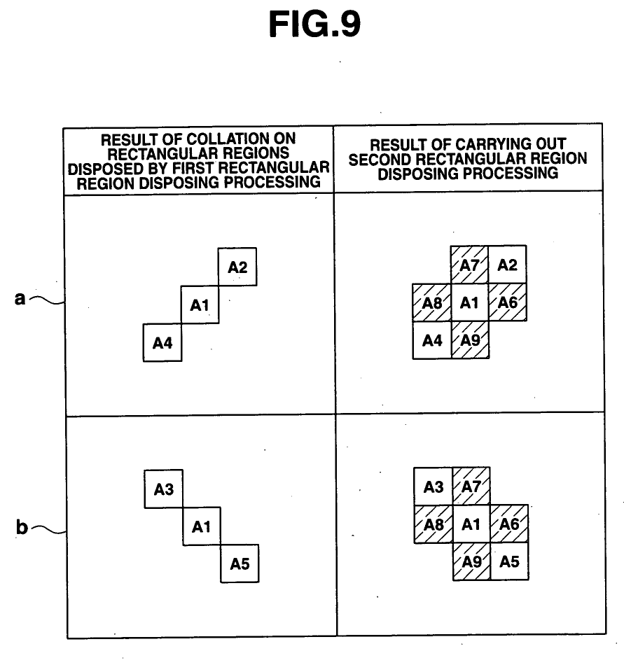

FIG. 9 also shows a positional relation of rectangular regions when three rectangular regions are provided. In symbols “a” and “b” in FIG. 9, of the rectangular regions A2, A3, A4 and A5 disposed around the rectangular region A1, two regions opposing each other across the rectangular region A1 are not contained. In this case, four rectangular regions Ai's {Ai|6≦i≦9} are disposed such that they are adjacent to the rectangular region A1 in the second rectangular region disposing processing. For example, in symbol “a” in FIG. 9, the rectangular regions Ai's {Ai|6≦i≦9} are disposed so as to adjoin the rectangular region A1, whereby four rectangular regions are disposed away from the positions at which the rectangular regions A3 and A5 whose relative deflection amount is determined not to be smaller than the specified deflection amount.

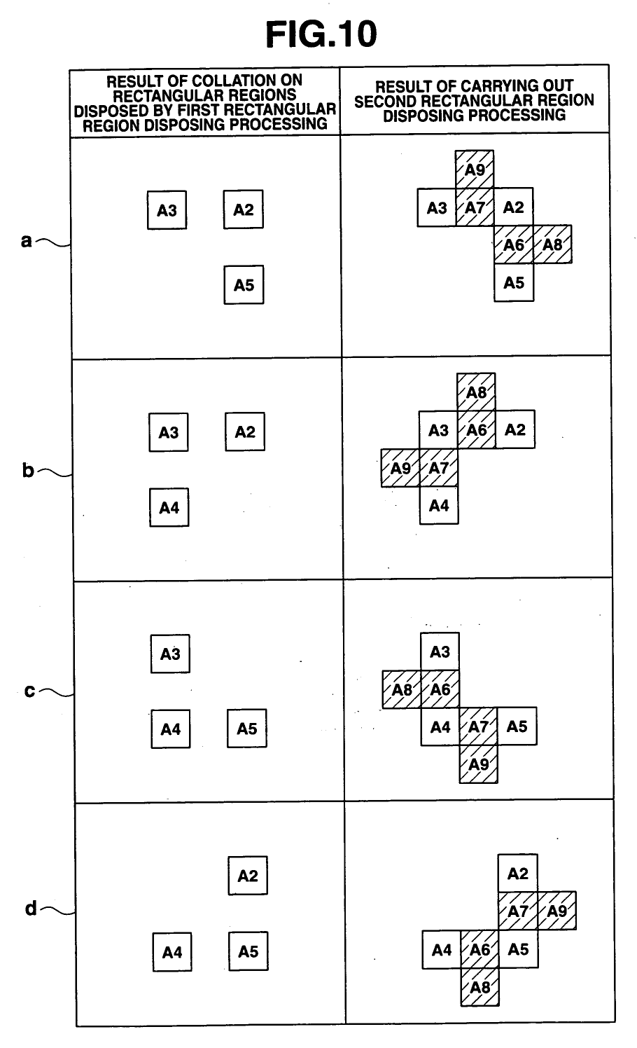

FIG. 10 also shows a relational relation of rectangular regions when three rectangular regions are provided. In symbols “a” to “d” in FIG. 10, the rectangular region A1 and one of the rectangular regions A2, A3, A4 and A5 disposed around the rectangular region A1 are not contained. In this case, four rectangular regions Ai's {Ai|6≦i≦9} are disposed so as to be in contact with rectangular regions whose deflection is determined to be smaller than the specified deflection amount, in the second rectangular region disposing processing. For example, in symbol “a” in FIG. 10, the rectangular region A7 is disposed between the rectangular regions A2 and A3, and the rectangular region A9 is disposed adjacent to the rectangular region A7. Likewise, the rectangular region A6 is disposed between the rectangular regions A2 and A5, and further, the rectangular region A8 is disposed adjacent to the rectangular region A6. In this case also, the rectangular region A1 whose relative deflection amount is determined not to be smaller than the specified deflection amount is not contained, and four rectangular regions are disposed on an opposite side to the position at which the rectangular region A4 is disposed and the central position (rectangular region A1).

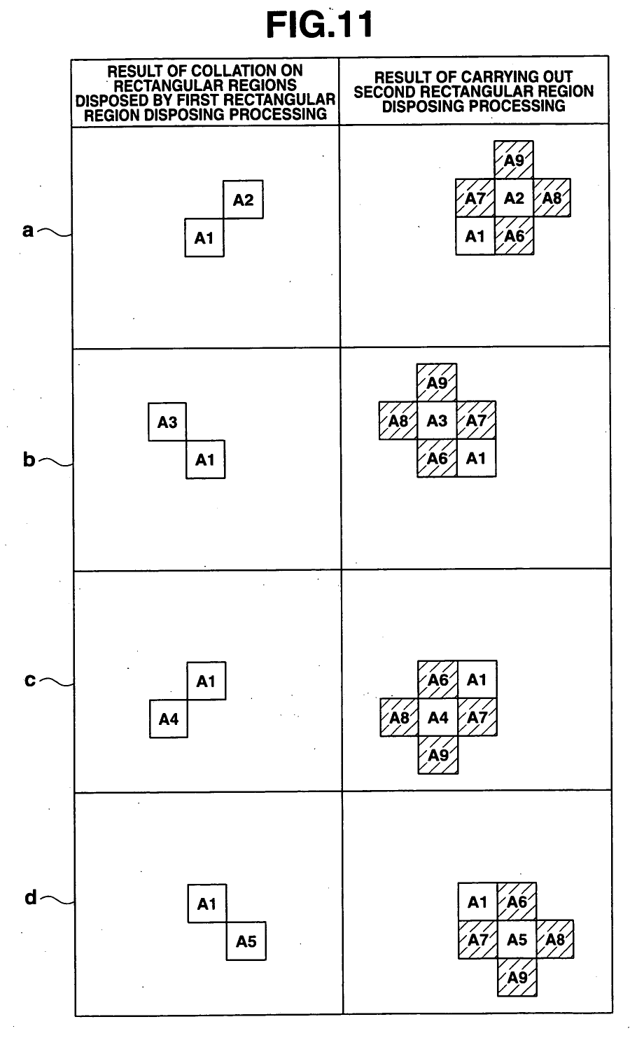

FIG. 11 also shows a positional relation of rectangular regions when two rectangular regions are provided. In symbols “a” to “d” in FIG. 11, there are provided only the rectangular region A1 and one of the rectangular regions A2, A3, A4 and A5 disposed around the rectangular region A1. In this case, in the second rectangular region disposing processing, four rectangular regions Ai's {Ai|6≦i≦9} are disposed so as to be in contact with any one of the rectangular regions A2, A3, A4 and A5 whose deflection is determined to be smaller than the specified deflection amount. For example, in symbol “a” in FIG. 11, four rectangular regions Ai's {Ai|6≦i≦9} are disposed such that they are adjacent to the rectangular region A2.

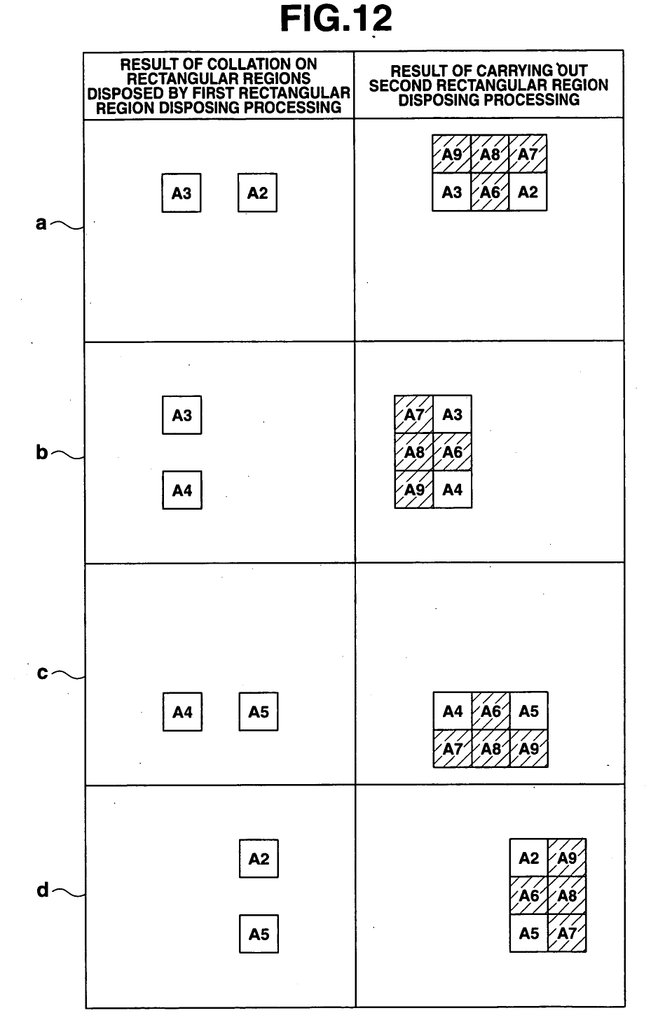

FIG. 12 also shows a positional relation of rectangular regions when two rectangular regions are provided. The cases indicated with symbols “a” to “d” in FIG. 12 each are constituted of only two rectangular regions disposed vertically or horizontally of the rectangular regions A2, A3, A4 and A5 disposed around the rectangular region A1. In this case, four rectangular regions Ai's {Ai|6≦i≦9} are disposed so as to be in contact with two of the rectangular regions A2, A3, A4 and A5 whose deflection amount is determined to be smaller than the specified deflection amount. For example, in symbol “a” in FIG. 12, the rectangular region A6 is disposed between the rectangular regions A2 and A3. Further, the rectangular region A8 is disposed at a position which makes contact with the vertexes of the rectangular regions A2 and A3 or adjacent to the rectangular region A6, the rectangular region A9 is disposed at a position which is adjacent to the rectangular regions A3 and A8, and the rectangular region A7 is disposed at a position which is adjacent to the rectangular regions A2 and A8.

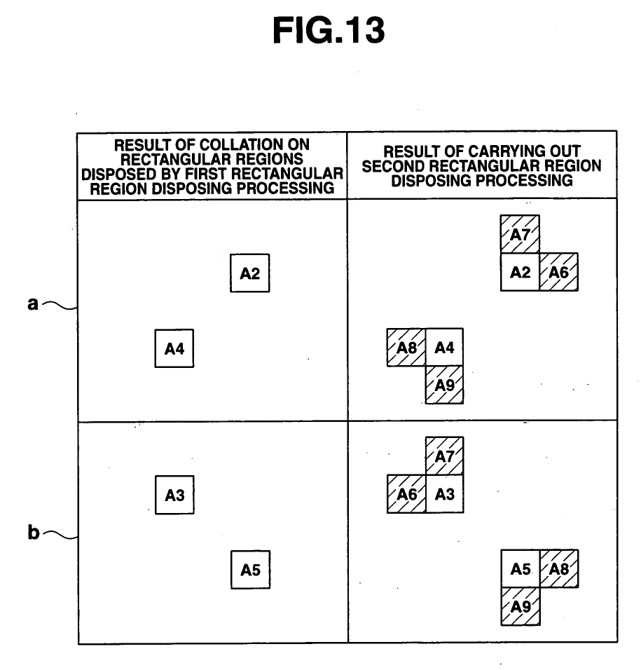

FIG. 13 also shows a positional relation of rectangular regions when two rectangular regions are provided. The cases indicated with symbols “a” and “b” in FIG. 13 include only two regions opposing each other across the rectangular region A1, of the rectangular regions A2, A3, A4 and A5 disposed around the rectangular region A1. In this case, two rectangular regions Ai's {Ai|6≦i≦9} (totally four) are disposed such that they are adjacent to each of the two rectangular regions opposing each other, in the second rectangular region disposing processing. For example, in symbol “a” in FIG. 13, the two rectangular regions A6 and A7 are disposed so as to adjoin the rectangular region A2 and so as to oppose a position at which the rectangular region A1 has been disposed, and then, the two rectangular regions A8 and A9 are disposed so as to adjoin the rectangular region A4 and so as to oppose a position at which the rectangular region A1 has been disposed.

In this way, as for the positional relation of rectangular regions constituted of only rectangular regions whose relative deflection amount is smaller than the specified deflection amount, variable arrangement of the rectangular regions can be made only by defining the arrangement relation of remaining rectangular regions in each case.

According to the image collator of the first embodiment, the rectangular regions are disposed at other places than a distorted region, a crushed region so that the shade is uniform or a blurred region by not collating all rectangular regions to be disposed in conditions in which they are disposed in a fixed positional relation but by disposing part of the rectangular regions to be arranged variably. Consequently, the ratio of rejection originating from distortion, crush and blur of the collation image data can be reduced.

Although according to the first embodiment, rectangular regions (templates) of the same size are disposed in the registered image data A, they may be disposed in a region of an arbitrary shape and an arbitrary size. A region having the maximum correlation coefficient in a region of the same shape as a region disposed in the registered image data A is detected from the collation image data B.

Although according to the first embodiment, the rectangular regions are disposed in the registered image data A, they may be disposed in the collation image data B.

Further, according to the first embodiment, plural rectangular regions are disposed with the center of the registered image data A as a reference. However, they may be disposed with other positions as a reference, such as the gravity center of the registered image data A.

In addition, although according to the first embodiment, respective rectangular regions are disposed in a contact state, they may be disposed in an overlapping state or a separated state.

Moreover, according to the first embodiment, the rotation conversion processing is carried out on the entire registered image data A, but the rotation conversion processing may be carried out on respective rectangular regions.

### SECOND EMBODIMENT

An image collator according to a second embodiment has the same functional configuration as those in FIG. 1 used for explanation of the first embodiment, and operates as follows.

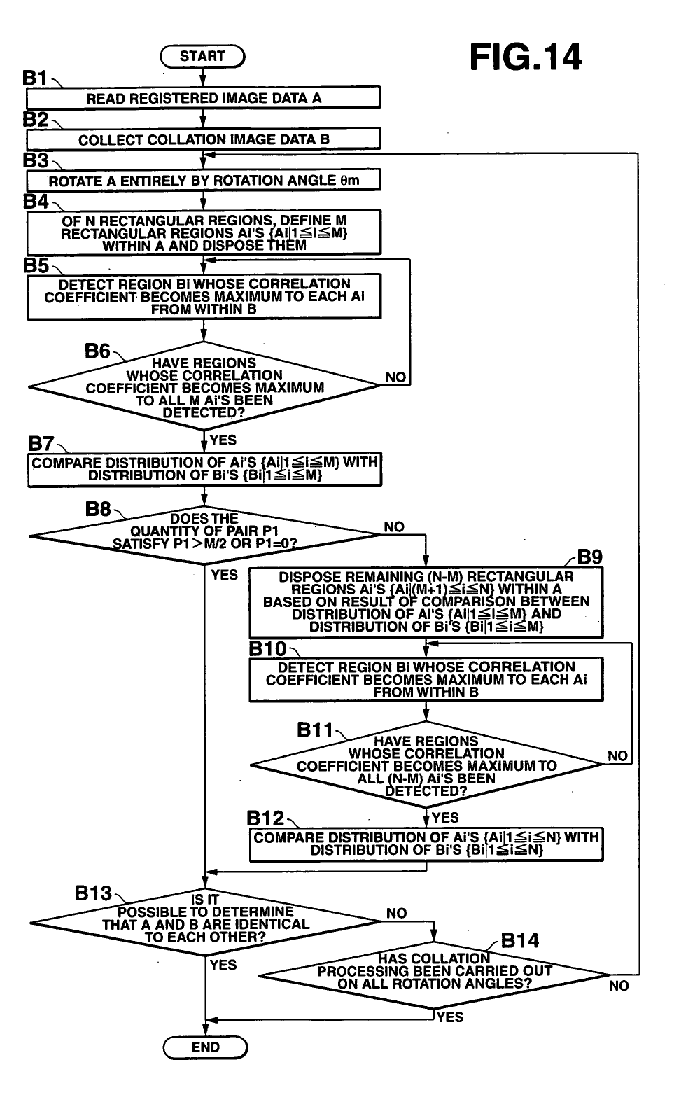

The operation of the image collator applied to fingerprint collation will be described with reference to a flow chart shown in FIG. 14.

According to the second embodiment, it is assumed that registration processing is carried out on fingerprint image data collected by the image data input unit 3 by the registration unit 2 and stored in the registered image data storage unit 1. Like the first embodiment, a case of disposing nine (N) (M=5) rectangular regions will be described with reference to FIGS. 4A, 4B and 4C.

Processing of steps B1 to B6 shown in FIG. 14 carries out the same processing as steps A1 to A6 of the flow chart shown in FIG. 3 described in the first embodiment, and thus, detailed description thereof is omitted.

The image processing unit first disposes M rectangular regions Ai's {Ai|1≦i≦M} on the registered image data A in a fixed positional relation, and detects regions Bi's {Bi|1≦i≦M} capable of obtaining the maximum correlation coefficient with respect to the M rectangular regions Ai's {Ai|1≦i≦M} from the collation image data B (steps B1 to B6). Then, the distribution of the rectangular regions Ai's {Ai|1≦i≦M} and the distribution of the rectangular regions Bi's {Bi|1≦i≦M} are compared. When a region having the maximum correlation coefficient with respect to each of the M rectangular regions Ai's {Ai|1≦i≦5} is detected (step B6: Yes), the collation determination unit 9 compares the distribution of the rectangular regions Ai's {Ai|1≦i≦5} with the distribution of the rectangular regions Bi's {Bi|1≦i≦5}. A region in which the relative deflection amount of each of the rectangular regions Bi's {Bi|1≦i≦5} to each of the rectangular regions Ai's {Ai|1≦i≦5} is smaller than the specified deflection amount is detected. Then, the quantity of pairs P1 of regions whose deflection amount is small is calculated (step B7).

Next, it is judged whether or not the quantity of pairs P1 of regions satisfies P1>M/2 or P1=0 (step B8).

If P1>M/2, that is, the quantity of region pairs is three or more (step B8: Yes), the procedure proceeds to the next determination step, in which it is determined whether or not the registered image data A and the collation image data B are identical to each other (step B13). When it is determined that the image data are identical to each other, the collation result display unit 5 outputs a determination result by the collation determination unit 9, indicating that the collation image data B and the registered image data A are identical to each other.

It is evident that the image data cannot be determined to be identical to each other when P1=0 (step B8: Yes). Therefore, disposing of regions for the second time is omitted, and the procedure proceed to the next step B13, in which identity cannot be determined in this step, and then, the procedure proceeds to step B14. Then, it is determined whether or not the collation processing of steps B3 to B7 has been carried out on all the rotation angles θm. When the processing on all the rotation angles θm is ended (step B14: Yes), it is finally determined that the registered image data A and the collation image data B are not identical to each other. In this case, the collation result display unit 5 outputs a determination result by the collation determination unit 9, indicating that the collation image data B is not identical to the registered image data A.

When 0≦P1≦M/2, on the other hand, it is considered that the reason for determining that they are identical images is insufficient. Then, the region disposing unit 7 decides the arrangement positions of remaining four ((N−M)) rectangular regions Ai's {Ai|6≦i≦9} and disposes them in a positional relation of rectangular regions constituted of only rectangular regions whose relative deflection amount is smaller than the specified deflection-amount when the specified quantity of region pairs is obtained (hereinafter referred to as second rectangular region disposing processing) (step B9).

Because the arrangement relation of rectangular regions whose relative deflection amount is smaller than the specified deflection amount is A1, A3 and A4 (B1, B3, B4), remaining rectangular regions are disposed according to a preliminarily determined arrangement relation with respect to the positional relation of the rectangular regions. According to the second embodiment as well, remaining rectangular regions are disposed according to the preliminarily determined arrangement relation with respect to the positional relation of the rectangular regions defined as shown in FIGS. 5 to 13 as explained in the first embodiment.

As shown in FIG. 4C, the maximum correlation region detecting unit 8 detects rectangular regions Bi's {Bi|6≦i≦9} capable of obtaining the maximum correlation coefficient to the respective rectangular regions Ai's {Ai|6≦i≦9} by scanning the remaining rectangular regions Ai's {Ai|6≦i≦9} newly disposed on the collation image data B.

If a region whose correlation coefficient is maximum is detected to each of all (N−M) Ai's (step B11: Yes), the collation determination unit 9 detects a rectangular region whose relative deflection of each of the rectangular regions Bi's {Bi|1≦i≦9} to each of the rectangular regions Ai's {Ai|1≦i≦9} is smaller than the specified deflection amount by comparing the distribution of the rectangular regions Ai's {Ai|1≦i≦9} with the distribution of the rectangular regions Bi's {BI|1≦i≦9}, and calculates the quantity of pairs P2 of regions (step B12). Then, if the quantity of region pairs P2 is larger than a specified quantity of region pairs, it is determined that the registered image data A and the collation image data B are identical to each other (step B13: Yes).

The collation result display unit 5 outputs a determination result by the collation determination unit 9, indicating that the collation image data B and the registered image data A are identical to each other.

If the quantity of region pairs P2 is smaller than the specified quantity of region pairs, on the other hand, it is determined that the image data are not identical to each other, and the procedure proceeds to step B14, in which it is determined whether or not the processing of steps B3 to B7 has been carried out on all the rotation angles θm. When the processing to the all rotation angles θm is ended (step B14: Yes), it is determined that the registered image data A and the collation image data B are not identical to each other.

The collation result display unit 5 outputs a determination result by the collation determination unit 9, indicating that the collation image data B is not identical to the registered image data A.

Unless the processing to the all rotation angles θm is ended (step B14: No), the rotation angle θm is changed under m=m+1, and the procedure returns to step B3, in which the aforementioned processing is carried out.

According to the above-described explanation, if the quantity of region pairs P1>M/2 is provided as a result of comparing the distribution of the rectangular regions Ai's (Ai|1≦i≦M} with the distribution of the rectangular regions Bi's {Bi|1≦i≦M}, remaining (N−M) rectangular regions Ai's {Ai|M+1≦i≦N} are not disposed. However, a reference value for determination to P1 is not restricted to M/2. This reference value can be set to another arbitrary value as long as a sufficient effective result can be obtained without collating with the remaining rectangular regions disposed.

In this way, the second embodiment enables reduction of the erroneous rejection ratio owing to distortion, crush and blur of the collation image data like the first embodiment. Further, if the quantity of pairs P1 of regions satisfies P1>M/2 or P1=0, the collation processing is carried out to rectangular regions disposed by the second rectangular region disposing processing by omitting a processing of detecting a region in which the maximum correlation coefficient can be obtained. As a result, the collation time can be reduced as compared with the first embodiment.

Also according to the second embodiment, regions of an arbitrary shape and an arbitrary size may be disposed as well as rectangular regions (templates) of the same size in the same manner as in the first embodiment. Further, although the rectangular regions are disposed within the registered image data A, they may be also disposed within the collation image data B. Furthermore, as well as around the registered image data A, plural rectangular regions may be disposed with another position such as the gravity center as a reference. Although the respective rectangular regions are disposed in the contact state, they may be disposed in an overlapping state or in a separated state. In addition, the rotary conversion processing is carried out on the entire registered image data A, but this may be carried out on each of the rectangular regions.

As the rectangular regions disposed by the second rectangular region disposing processing, all the (N−M) rectangular regions except rectangular regions disposed fixedly by the first rectangular region disposing processing are disposed. However, it is permissible to dispose only part of the rectangular regions. For example, depending on the quantity of pairs of rectangular regions (quantity of region pairs) whose relative deflection amount is smaller than the specified deflection amount, the quantity being obtained by comparing the distribution of the rectangular regions Ai's disposed on the registered image data A with the distribution of the rectangular regions Bi's detected from the collation image data B, the quantity of rectangular regions to be disposed by the second rectangular region disposing processing can be decided. For example, as the quantity of region pairs increases, the quantity of rectangular regions disposed by the second rectangular region disposing processing can be reduced.

The image collator of each embodiment can be achieved with a configuration which a standard level computer possesses. Therefore, the functions of the above-described embodiments can be achieved by writing an image collation program to be executed by a computer which achieves the image collator of each embodiment, into a recording medium such as, for example, a magnetic disk (flexible disk, hard disk, etc), an optical disk (CD-ROM, DVD, etc.), or a semiconductor memory, then providing this program through a communication medium, and controlling the operation of the computer according to the image collation program.

The above-described embodiments include inventions of various stages, so that various kinds of aspects of the invention can be extracted by appropriately combining disclosed plural components of the invention. For example, even if some components are erased from all the components indicated in the embodiments, at least one object described in the Problems to be Solved by the Invention is obtained, and at least one of effects described in the advantages of the invention is obtained. In this case, a composition excluding those components can be extracted as another aspect of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image collator for collating a first fingerprint image with a second fingerprint image, comprising:
a first region disposing unit which disposes plural first regions on the first fingerprint image in a fixed positional relation;
a first maximum correlation region detecting unit which detects a maximum correlation region whose correlation with image data of each of the first regions disposed by the first region disposing unit becomes maximum from the second fingerprint image;
a second region disposing unit which disposes plural second regions on the first fingerprint image in accordance with a positional relation of the maximum correlation regions detected by the first maximum correlation region detecting unit;
a second maximum correlation region detecting unit which detects a region whose correlation with image data of each of the second regions disposed by the second region disposing unit from the second fingerprint image; and
a determining unit which determines whether or not identity exists between the first fingerprint image and the second fingerprint image by comparing the distribution of the regions disposed by the first region disposing unit and the second region disposing unit with the distribution of the maximum correlation regions detected by the first maximum correlation region detecting unit and the second maximum correlation region detecting unit.

2. The image collator according to claim 1, further comprising:
a detecting unit which detects a region in which the amount of deflection between the first region disposed by the first region disposing unit and the maximum correlation region detected by the first correlative region detecting unit is smaller than a predetermined value, wherein
the second region disposing unit disposes the second region on the basis of a pattern corresponding to a positional relation of regions whose deflection amount is determined to be small by the detecting unit.

3. The image collator according to claim 2, wherein the first region disposing unit disposes one rectangular region and four rectangular regions to be disposed so as to surround the one rectangular region on the first fingerprint image, and the second region disposing unit disposes the second region in contact with the first region whose deflection amount is detected to be small by the detecting unit.

4. The image collator according to claim 3, further comprising an image rotating unit which, before the first region disposing unit disposes the first regions, executes rotation processing on the first fingerprint or second fingerprint by a predetermined quantity.

5. An image collator for collating a first fingerprint image with a second fingerprint image, comprising:
a first region disposing unit which disposes plural first regions on the first fingerprint image in a fixed positional relation;
a first maximum correlation region detecting unit which detects a maximum correlation region whose correlation with image data of each of the first regions disposed by the first region disposing unit becomes maximum from the second fingerprint image;
a judging unit which determines whether or not the collation is enabled by comparing the distribution of the regions disposed by the first region disposing unit with the distribution of the maximum correlation regions detected by the first maximum correlation region detecting unit;
a first determining unit which, when the determining unit determines that the collation is enabled, determines whether or not identity exists between the first fingerprint image and the second fingerprint image by comparing the distribution of the regions disposed by the first region disposing unit with the distribution of the maximum correlation regions detected by the first maximum correlation region detecting unit;
a second region disposing unit which, when the determining unit determines that the collation is not enabled, disposes plural second regions on the first fingerprint image in accordance with a positional relation of the maximum correlation regions detected by the first maximum correlation region detecting unit;
a second maximum correlation region detecting unit which detects a maximum correlation region whose correlation with image data of each of the second regions disposed by the second region disposing unit becomes maximum from the second fingerprint image; and
a second determining unit which determines whether or not identity exists between the first fingerprint image and the second fingerprint image by comparing the distribution of the regions disposed by the first region disposing unit and the second region disposing unit with the distribution of the maximum correlation regions detected by the first maximum correlation region detecting unit and the second maximum correlation region detecting unit.

6. The image collator according to claim 5, wherein the judging unit has a unit which calculates the quantity of regions in which the amount of deflection between the first region disposed by the first region disposing unit and the maximum correlation region detected by the first correlative region detecting unit is smaller than a predetermined value, and the determining unit determines whether or not the collation is enabled depending on whether or not the calculated value exceeds the predetermined value.

7. The image collator according to claim 6, wherein the first region disposing unit disposes one rectangular region and four rectangular regions to be disposed so as to surround the one rectangular region on the first fingerprint image, and the second region disposing unit disposes the second region in contact with the first region whose deflection amount is detected to be small.

8. The image collator according to claim 7, further comprising an image rotating unit which, before the first region disposing unit disposes the first regions, rotates the first fingerprint image or the second fingerprint image by a predetermined amount.

9. An image collation method for collating a first fingerprint image with a second fingerprint image, the method comprising
disposing plural first regions on the first fingerprint image in a fixed positional relation;
detecting a first maximum correlation region whose correlation with image data of each of the disposed first regions becomes maximum from the second fingerprint image;
disposing plural second regions on the first fingerprint image in accordance with a positional relation of the detected maximum correlation regions;
detecting a second maximum correlation region whose correlation with image data of each of the disposed second regions becomes maximum from the second fingerprint image; and
determining whether or not identity exists between the first fingerprint image and the second fingerprint image by comparing the distribution of the first and second regions with the distribution of the first and second maximum correlation regions.

10. The image collation method according to claim 9, further comprising:
detecting a region in which the amount of deflection between the disposed first region and the detected maximum correlation region is smaller than a predetermined value, wherein
the disposing second regions disposes the second region on the basis of a pattern corresponding to a positional relation of regions whose deflection amount is determined to be small.

11. The image collation method to claim 10, wherein the disposing first regions disposes one rectangular region and four rectangular regions to be disposed so as to surround the one rectangular region on the first fingerprint image, and the disposing second regions disposes the second region in contact with the first region whose deflection amount is detected to be small.

12. The image collation method according to claim 11, further comprising:
before disposing the first regions, rotating the first fingerprint image or the second fingerprint image by a predetermined amount.

13. An image collation method for collating a first fingerprint image with a second fingerprint image, the method comprising:
disposing plural first regions on the first fingerprint image in a fixed positional relation;
detecting a first maximum correlation region whose correlation with image data of each of the disposed first regions becomes maximum from the second fingerprint image;
determining whether or not the collation is enabled by comparing the distribution of the disposed first regions with the distribution of the detected first maximum correlation regions;
when it is determined that the collation is enabled, determining whether or not identity exists between the first fingerprint image and the second fingerprint image by comparing the distribution of the disposed first regions with the distribution of the detected first maximum correlation regions;
when it is determined that the collation is not enabled, disposing plural second regions on the first fingerprint image in accordance with a positional relation of the detected first maximum correlation regions;
detecting a second maximum correlation region whose correlation with image data of each of the disposed second regions becomes maximum from the second fingerprint image; and
determining whether or not identity exists between the first fingerprint image and the second fingerprint image by comparing the distribution of the first and second regions with the distribution of the first and second maximum correlation regions.

14. The image collation method according to claim 13, wherein the determining has calculating the quantity of regions in which the amount of deflection between the disposed first region and the detected first maximum correlation region is smaller than a predetermined value, and determines whether or not the collation is enabled depending on whether or not the calculated value exceeds the predetermined value.

15. The image collation method according to claim 14, wherein the disposing first regions disposes one rectangular region and four rectangular regions to be disposed so as to surround the one rectangular region on the first fingerprint image, and the disposing second regions disposes the second region in contact with the first region whose deflection amount is detected to be small.

16. The image collation method according to claim 15, further comprising:
before disposing the first regions, rotating the first fingerprint image or the second fingerprint image by a predetermined amount.
